(19) United States
(12) Patent Application Publication
(10) Pub. No.: US 2023/0388169 A1
(43) Pub. Date: Nov. 30, 2023

(54) TRANSMISSION DEVICE

(71) Applicant: Fujitsu Limited, Kawasaki-shi (JP)

(72) Inventors: Pengwen CAO, Yokohama (JP); Atsushi IMORI, Chiba (JP); Yusuke TOBISU, Yokohama (JP); Masakazu YAMAGISHI, Kawasaki (JP); Hirofumi Homma, Yokohama (JP)

(73) Assignee: Fujitsu Limited, Kawasaki-shi (JP)

(21) Appl. No.: 18/108,088

(22) Filed: Feb. 10, 2023

(30) Foreign Application Priority Data
May 30, 2022 (JP) 2022-087935

(51) Int. Cl. H04L 27/26; H04L 25/08

(52) U.S. Cl. CPC H04L 27/2618; H04L 25/08; H04L 27/2628

(57) ABSTRACT

A transmission device includes a memory, and a processor coupled to the memory and configured to sample a first transmission signal obtained by performing baseband processing on a baseband signal, output the sampled first transmission signal; generate a peak reduction signal that reduces a signal level of all samples in such a manner that the signal level of all the samples of a peak of the first transmission signal with the signal level equal to or higher than a predetermined threshold is reduced to be lower than the threshold, output a second transmission signal obtained by reducing the peak of the first transmission signal with the peak reduction signal, and transmit the second transmission signal.

### CROSS-REFERENCE TO RELATED APPLICATION

This application is based upon and claims the benefit of priority of the prior Japanese Patent Application No. 2022-87935, filed on May 30, 2022, the entire contents of which are incorporated herein by reference.

### FIELD

The embodiment discussed herein is related to a transmission device.

### BACKGROUND

There has been a transmission device including: a first inverse Fourier transformer that generates a first time domain signal from a first modulated signal generated in a first modulation scheme and allocated in a first frequency band; a second inverse Fourier transformer that generates a second time domain signal from a second modulated signal generated in a second modulation scheme and allocated in a second frequency band; a clipping noise signal generator that generates a clipping noise signal representing a difference between power of a combined signal of the first time domain signal and the second time domain signal and a predetermined threshold in a time period in which the power of the combined signal is higher than the predetermined threshold; a first calculator that subtracts the clipping noise signal to which a first coefficient is multiplied from the first time domain signal; a second calculator that subtracts the clipping noise signal to which a second coefficient is multiplied from the second time domain signal; a first frequency filter that filters an output signal of the first calculator; a second frequency filter that filters an output signal of the second calculator; and a combiner that generates a transmission signal including an output signal of the first frequency filter and an output signal of the second frequency filter.

Japanese Laid-open Patent Publication No. 2016-039419 is disclosed as related art.

### SUMMARY

According to an aspect of the embodiments, a transmission device includes: a memory; and a processor coupled to the memory and configured to: sample a first transmission signal obtained by performing baseband processing on a baseband signal; output the sampled first transmission signal; generate a peak reduction signal that reduces a signal level of all samples in such a manner that the signal level of all the samples of a peak of the first transmission signal with the signal level equal to or higher than a predetermined threshold is reduced to be lower than the threshold; output a second transmission signal obtained by reducing the peak of the first transmission signal with the peak reduction signal; and transmit the second transmission signal.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an exemplary configuration of a transmission device 100 according to an embodiment;

FIG. 2 is a diagram for explaining exemplary comparative peak processing;

FIG. 3 is a diagram illustrating exemplary waveforms of a transmission signal, a peak reduction signal, and a transmission signal after peak reduction in the comparative peak processing;

FIG. 4 is a diagram for explaining a method of generating a model waveform to be used by a peak processing unit 130 to generate a peak reduction signal;

FIG. 5 is a diagram illustrating an exemplary configuration of the peak processing unit 130;

FIG. 6 is a diagram illustrating exemplary waveforms of a first transmission signal, a peak reduction signal, and a second transmission signal in peak processing according to the embodiment;

FIG. 7 is a diagram illustrating four peak reduction signals, a first transmission signal before peak reduction, and a second transmission signal after peak reduction;

FIG. 8 is a diagram illustrating a relationship between error vector magnitude (EVM) and a PAPR of the first transmission signal transmitted from an antenna 190 of the transmission device 100; and

FIG. 9 is a diagram for explaining a method of generating a model waveform of a peak reduction signal to be used by a peak processing unit 130 to generate the peak reduction signal according to a variation of the embodiment.

### DESCRIPTION OF EMBODIMENTS

Meanwhile, while a peak-to-average power ratio (PAPR) may be reduced when peak power of transmission signals is reduced, the PAPR may not be efficiently reduced when the peak power is not appropriately reduced.

In view of the above, it is aimed to provide a transmission device capable of efficiently reducing a PAPR of transmission signals.

Hereinafter, an embodiment to which a transmission device according to the present disclosure is applied will be described.

### EMBODIMENT

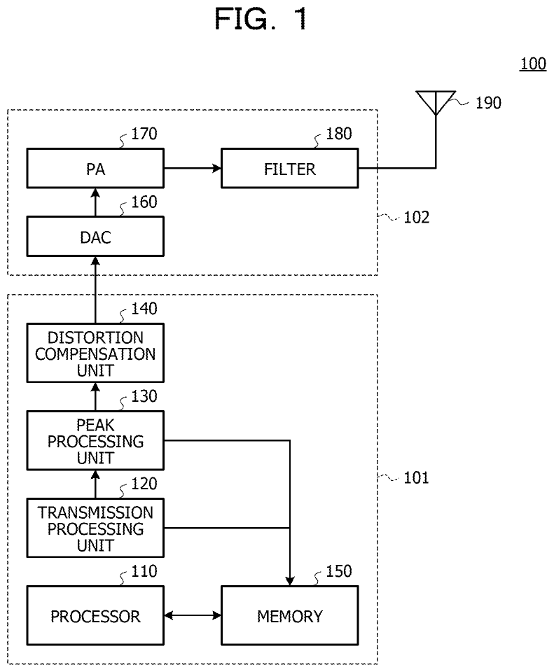

FIG. 1 is a diagram illustrating an exemplary configuration of a transmission device 100 according to an embodiment. The transmission device 100 includes a processor 110, a transmission processing unit 120, a peak processing unit 130, a distortion compensation unit 140, a memory 150, a digital-to-analog converter (DAC) 160, a power amplifier (PA) 170, a filter 180, and an antenna 190. The processor 110, the transmission processing unit 120, the peak processing unit 130, and the distortion compensation unit 140 are implemented by an integrated circuit (IC) 101 as a semiconductor device. The DAC 160, the PA 170, and the filter 180 are included in a transmission stage 102. The processor 110 is an exemplary information processing unit. The memory 150 is an exemplary storage unit.

The processor 110 reads transmission data from the memory, and outputs it to the transmission processing unit 120. The processor 110 controls the transmission processing unit 120 that performs baseband processing.

The transmission processing unit 120 performs the baseband processing on the transmission data input from the processor 110. The transmission processing unit 120 samples a signal level of a first transmission signal at a predetermined sampling period, and outputs the sampled first transmission signal to the peak processing unit 130. The first transmission signal is a transmission signal before peak reduction.

The peak processing unit 130 generates a peak reduction signal for reducing the signal levels of all samples whose peak signal levels of the first transmission signals input from the transmission processing unit 120 are equal to or higher than a predetermined threshold to be lower than the predetermined threshold. The peak processing unit 130 outputs a second transmission signal obtained by reducing the peak of the first transmission signal with the peak reduction signal. The second transmission signal is a transmission signal after the peak reduction.

The distortion compensation unit 140 applies a compensation signal to the second transmission signal, which is a second transmission signal input from the peak processing unit 130, based on, for example, an inverse characteristic of a distortion characteristic generated when the PA 170 amplifies signals, and outputs it.

The memory 150 stores programs, data, and the like to be used for processing performed by the IC 101 of the transmission device 100.

The DAC 160 performs analog conversion on the second transmission signal input from the distortion compensation unit 140, and outputs an analog second transmission signal.

The PA 170 amplifies the signal level of the analog second transmission signal input from the DAC 160, and outputs it.

The filter 180 removes noise from the analog second transmission signal input from the PA 170, and outputs it to the antenna 190. The filter 180 is, for example, a bandpass filter that passes a predetermined band.

The antenna 190 radiates the analog second transmission signal input from the filter 180. The analog second transmission signal radiated from the antenna 190 is, for example, an orthogonal frequency division multiplexing (OFDM) signal.

<Comparative Peak Processing>

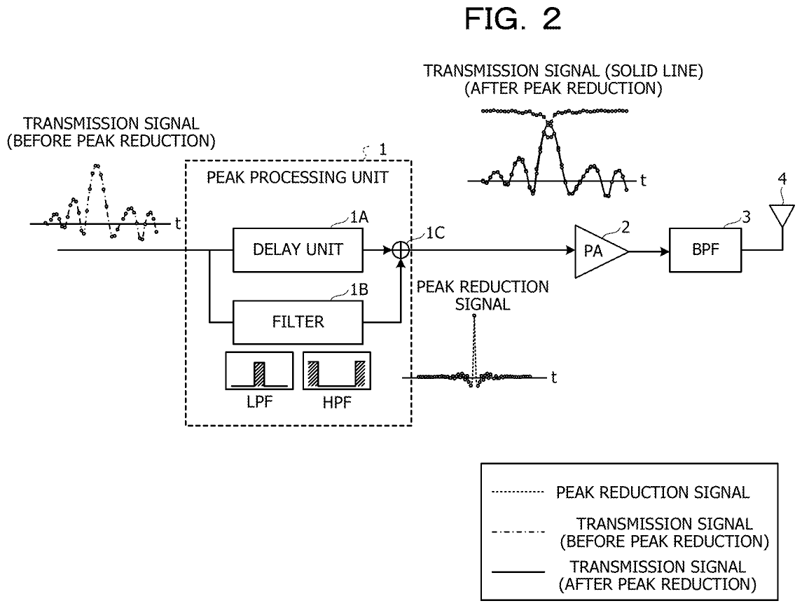

FIG. 2 is a diagram for explaining exemplary comparative peak processing. FIG. 2 illustrates a comparative peak processing unit 1, PA 2, band pass filter (BPF) 3, and antenna 4. The PA 2, the BPF 3, and the antenna 4 correspond to the PA 170, the filter 180, and the antenna 190 illustrated in FIG. 1. A DAC is omitted in FIG. 2.

Transmission signals are input to the peak processing unit 1 from a transmission processing unit that performs baseband processing. The peak processing unit 1 includes a delay unit 1A, a filter 1B, and an adder 1C. The delay unit 1A and the filter 1B are provided in parallel, and outputs of the delay unit 1A and the filter 1B are added by the adder 1C, subject to analog conversion performed by the DAC (not illustrated), and output to the PA 2.

The delay unit 1A adds, to a transmission signal, a delay time for matching timing with a signal passing through the filter 1B. The filter 1B is implemented by, for example, a low pass filter (LPF), a high pass filter (HPF), a bandpass filter combining the LPF and the HPF, or the like. The passband of the filter 1B is set to a band for generating a peak reduction signal for reducing the peak signal level of the transmission signal based on the transmission signal.

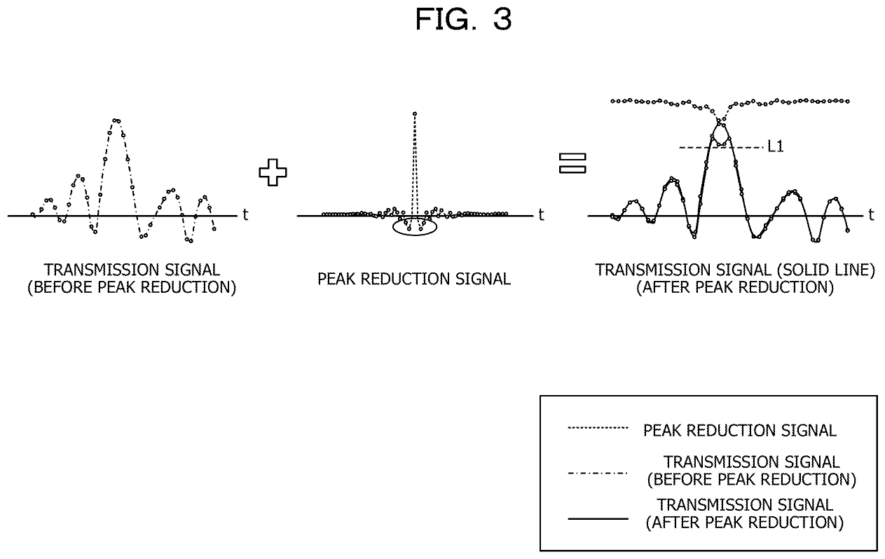

FIG. 3 is a diagram illustrating exemplary waveforms of the transmission signal, the peak reduction signal, and the transmission signal after peak reduction in the comparative peak processing. For the waveforms of the transmission signal, the peak reduction signal, and the transmission signal after peak reduction, the horizontal axis represents time t, and the vertical axis represents a signal level. A signal level at the height of the horizontal axis is zero (zero level).

As indicated by the ellipse of the broken line, the peak reduction signal generated by the filter 1B based on the transmission signal illustrated on the left has negative signal level values before and after the peak in the time axis direction, which deviate to the extent not regarded as an approximately zero level. When the positive/negative of such a peak reduction signal is inverted and added to the transmission signal, it results in the state as illustrated on the right of the equal sign.

On the right of the equal sign, the peak reduction signal is indicated by a broken line, the transmission signal before peak reduction is indicated by a dash-dotted line, and the transmission signal after peak reduction is indicated by a solid line.

As indicated by the solid line, while the transmission signal after peak reduction is lower than L1 at the central portion of the peak, it is not lower than L1 before and after the central portion of the peak in the time axis direction. The peak reduction signal is a peak reduction signal that makes the level of the transmission signal after peak reduction lower than L1.

The portions having the level of the transmission signal after peak reduction not lower than L1 are generated in this manner because there are portions that deviate from the zero level to the extent not regarded as the approximately zero level before and after the peak of the peak reduction signal in the time axis direction, as indicated by the ellipse of the broken line. When there is a portion that deviates from the zero level before and after the peak of the peak reduction signal, a difference between a PAPR of a transmission signal transmitted by a comparative transmission device including the comparative peak processing unit 1, PA 2, BPF 3, and antenna 4 from the antenna 4 and a PAPR achieved when the level of the transmission signal is made lower than L1 becomes so large as to be non-negligible in the practical use of the comparative transmission device.

<Model Waveform Generation Method According to Embodiment>

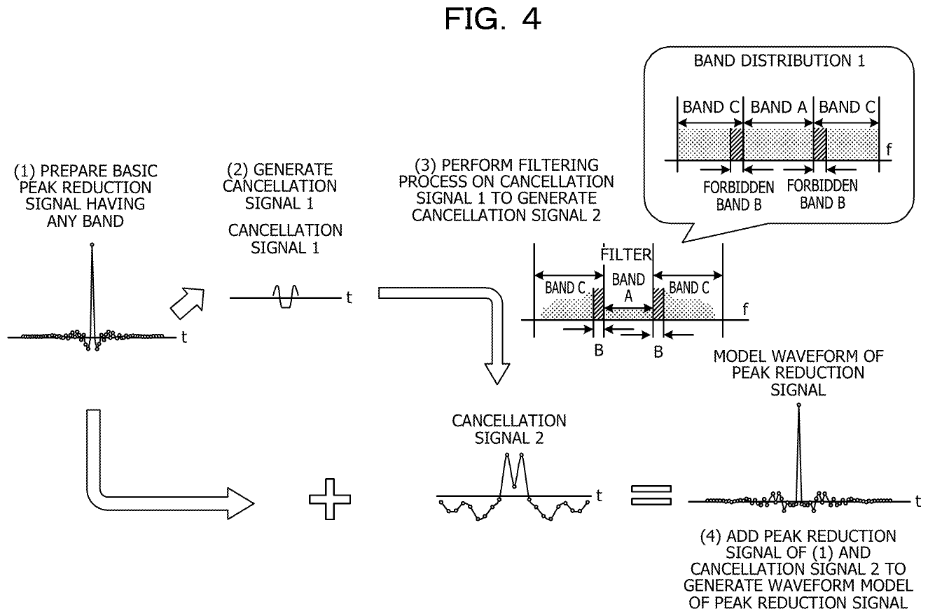

FIG. 4 is a diagram for explaining a method of generating a model waveform of a peak reduction signal to be used by the peak processing unit 130 to generate the peak reduction signal. In the embodiment, a model waveform generated as follows is used so that the level of the peak reduction signal before and after the peak in the time axis direction becomes the approximately zero level. Such model waveform may be generated in advance and stored in the memory 150. Generation of the model waveform may be carried out by an external device of the transmission device 100, for example.

Here, the approximately zero level indicates that the signal level before and after the peak of the peak reduction signal according to the embodiment is zero or at a level very close to zero. When the level of the peak reduction signal before and after the peak is the approximately zero level, there is no portion before and after the peak that deviates from the zero level, unlike the comparative peak reduction signal illustrated in FIG. 3. The approximately zero level indicates, for example, the signal level before and after the peak of the peak reduction signal according to the embodiment is within a range of ±5% of the peak. When a peak reduction signal having a signal level before and after the peak of the peak reduction signal at the approximately zero level is used, the PAPR of the second transmission signal transmitted by the transmission device 100 from the antenna 190 is sufficiently reduced to the level expected by the usage of the peak reduction signal. Note that ±5% is merely an example, and may be determined in consideration of the level at which the PAPR of the second transmission signal is sufficiently reduced. The approximately zero level indicates within a predetermined plus/minus range across the zero level.

As illustrated in (1) of FIG. 4, first, a basic peak reduction signal having any band is prepared. Here, as an example, it is sufficient if a peak reduction signal in a band conforming to the standards for the transmission device 100 is prepared as a basic peak reduction signal. The basic peak reduction signal is a signal having the model waveform of the ultimately generated peak reduction signal.

The standards for the transmission device 100 may be, for example, Third Generation Partnership Project (3GPP, registered trademark). Here, as an example, descriptions will be given assuming that the transmission device 100 uses the 3.7 GHz band. Accordingly, it is sufficient if the basic peak reduction signal prepared in (1) is a band-limited signal conforming to the 3.7 GHz band standards.

The basic peak reduction signal only needs to include one peak in the time axis direction, and the signal levels before and after the peak only need to be clearly lower than the peak, for example, equal to or lower than 1/10. The basic peak reduction signal only needs to include one peak, and the signal levels before and after the peak may be higher than the approximately zero level.

Next, as illustrated in (2), the signal levels at several points before and after the peak of the basic peak reduction signal are extracted, and the positive/negative of the extracted signal levels at the several points is inverted, thereby generating a cancellation signal 1. The cancellation signal 1 is an exemplary first inverted signal. The intervals of the signal levels at the several points in the time axis direction are equal to the time intervals when the transmission processing unit 120 performs sampling.

Next, as illustrated in (3), a filtering process is performed on the cancellation signal 1. For example, a cancellation signal 2 is generated by passing the cancellation signal 1 through a filter 1. The cancellation signal 2 is an exemplary second inverted signal.

FIG. 4 illustrates the filter 1 to be used for the filtering process of (3), and band distribution 1 to be used for the filter 1. Since the filter 1 is generated based on the band distribution 1, first, the band distribution 1 will be described.

The band distribution 1 includes a band A, forbidden bands B, and bands C determined by the standards for the transmission device 100 and the like. The standards for the transmission device 100 are, for example, 3GPP. The band A is, for example, a band of 3.75 GHz. FIG. 4 illustrates the forbidden bands B on the sides with lower and higher frequencies than the band A of 3.75 GHz. The forbidden bands B are in the bands C outside the band A (out of band).

The filter 1 passes components in the band A, and passes components in the bands C other than the forbidden bands B according to the band distribution 1. For example, the filter 1 cuts off signals of the forbidden bands B.

Furthermore, the filter 1 adjusts the amplitude at the time of passing signals. The height of the gray portion of the filter 1 in FIG. 4 represents a degree of the amplitude adjustment by the filter 1. For example, the filter 1 makes the amplitude of the signals to be passed relatively small at the time of passing the components in the band A, and increase the amplitude as the frequency of the signal is closer to the forbidden bands B at the time of passing the components in the bands C other than the forbidden bands B.

With the cancellation signal 1 passing through such a filter 1, the cancellation signal 2 is generated.

Finally, as illustrated in (4), the basic peak reduction signal prepared in (1) is combined with the cancellation signal 2 generated in (3), whereby the model waveform of the peak reduction signal is complete. The level before and after the peak of the model waveform of the peak reduction signal is the approximately zero level in the time axis direction.

<Peak Processing According to Embodiment>

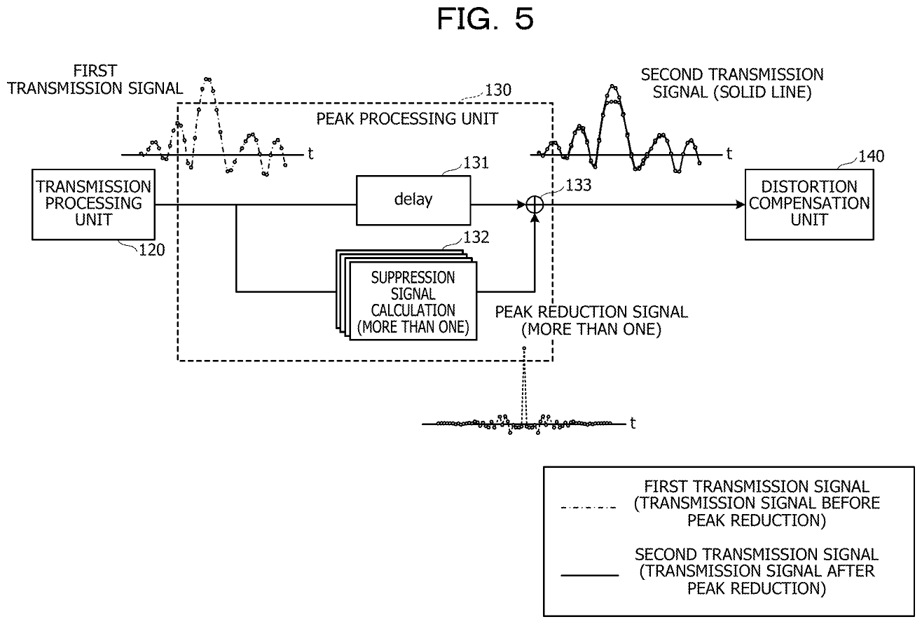

FIG. 5 is a diagram illustrating an exemplary configuration of the peak processing unit 130. FIG. 5 illustrates the distortion compensation unit 140 in addition to the peak processing unit 130.

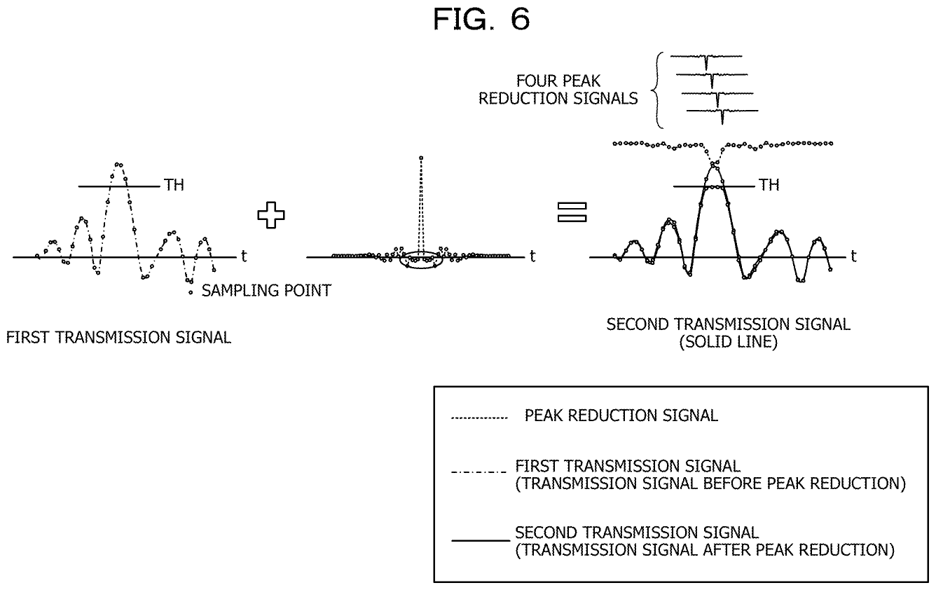

The peak processing unit 130 includes a delay unit 131, a plurality of signal generation units 132, and an adder 133. The delay unit 131 and the plurality of signal generation units 132 are provided in parallel, and outputs of the delay unit 131 and the plurality of signal generation units 132 are added by the adder 133, subject to analog conversion performed by the DAC (not illustrated), and output to the PA 170. The delay unit 131 adds, to the first transmission signal, a delay time for matching timing with a signal passing through the plurality of signal generation units 132. Processing of the plurality of signal generation units 132 will be described with reference to FIG. 6 in addition to FIG. 5.

FIG. 6 is a diagram illustrating exemplary waveforms of the first transmission signal, the peak reduction signal, and the second transmission signal in the peak processing according to the embodiment. For the waveforms of the first transmission signal, the peak reduction signal, and the second transmission signal, the horizontal axis represents time t, and the vertical axis represents a signal level. A signal level at the height of the horizontal axis with respect to the vertical axis represents zero (zero level). The first transmission signal is a transmission signal before being subject to the peak reduction by the peak processing unit 130, and the second transmission signal is a transmission signal after being subject to the peak reduction by the peak processing unit 130.

Each of the signal generation units 132 reads model waveform data of the peak reduction signal from the memory 150, and scales the model waveform according to the peak signal level equal to or higher than a predetermined threshold TH of the peak reduction signal, thereby generating a peak reduction signal.

For example, among the sampling points of the first transmission signal illustrated on the left side of the plus sign in FIG. 6, there are four sampling points equal to or higher than the threshold TH. In this case, each of four signal generation units 132 out of the plurality of signal generation units 132 sequentially obtains the signal levels of the four sampling points equal to or higher than the threshold TH in time series. Then, each of the four signal generation units 132 adjusts (scales) the amplitude of the model waveform according to the signal levels of the four sampling points, thereby generating four peak reduction signals in such a manner that the levels of the four sampling points after peak reduction become lower than the threshold TH. Each of the signal generation units 132 scales the model waveform according to the signal level of one of the four sampling points, thereby generating a peak reduction signal in such a manner that the level of the sampling point after peak reduction becomes lower than the threshold.

As indicated by the ellipse of the broken line, the peak reduction signal (central part of FIG. 6) generated by the peak processing unit 130 based on the first transmission signal illustrated on the left of FIG. 6 has an approximately zero signal level before and after the peak in the time axis direction. When the positive/negative of such a peak reduction signal is inverted and added to the first transmission signal, the second transmission signal after peak reduction as illustrated on the right of the equal sign is obtained.

On the right of the equal sign, the peak reduction signal is indicated by a broken line, the first transmission signal (transmission signal before peak reduction) is indicated by a dash-dotted line, and the second transmission signal (transmission signal after peak reduction) is indicated by a solid line. The peak reduction signal indicated by the broken line is a combined signal obtained by combining the four peak reduction signals illustrated on the upper side. The four peak reduction signals are generated by the four signal generation units 132, and each of them reduces a signal level of a sampling point different from each other, whereby the peak positions vary in the time axis direction.

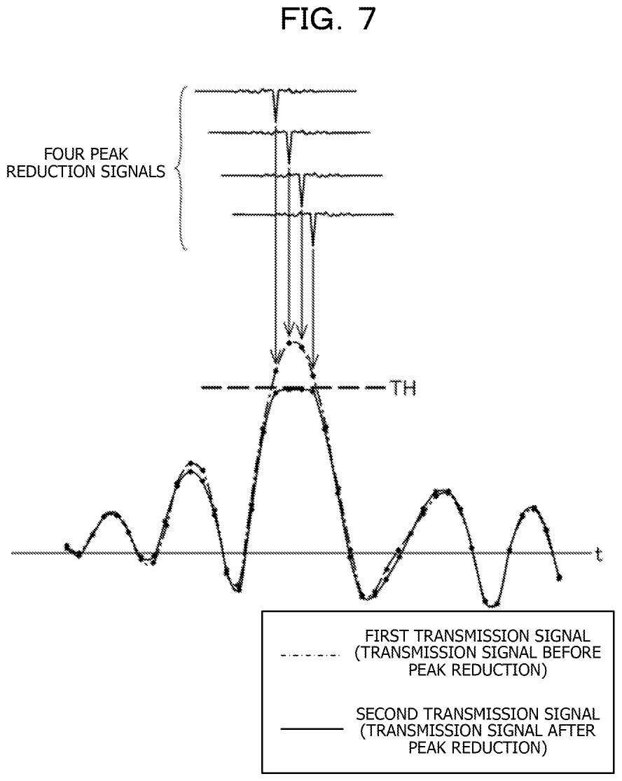

Here, descriptions will be given with reference to FIG. 7 in addition to FIG. 6. FIG. 7 is a diagram illustrating the four peak reduction signals (solid line), the first transmission signal before peak reduction (dash-dotted line), and the second transmission signal after peak reduction (solid line). In FIG. 7, the combined peak reduction signal (broken line) illustrated in FIG. 6 is omitted, and the correspondence between the four peak reduction signals and the four sampling points of the first transmission signal before peak reduction is indicated by arrows.

As indicated by the solid line on the right of the equal sign in FIG. 6, the signal levels at the four points of the peak reduction signal (broken line) obtained by combining the four peak reduction signals correspond to the peak signal levels of the four peak reduction signals. When each of the signal levels at the four sampling points of the first transmission signal before peak reduction (dash-dotted line) is lowered by the peak reduction signal (broken line) having such signal levels at four points, a second signal level after peak reduction (solid line) having the peak signal level lower than TH is obtained.

Explaining this with reference to FIG. 7, this corresponds to lowering each of the signal levels at the four sampling points of the first transmission signal before peak reduction (dash-dotted line) at the four peaks of the four peak reduction signals. In this manner, by generating four peak reduction signals having peak amplitude scaled according to the signal levels at the four sampling points of the first transmission signal before peak reduction (dash-dotted line), it becomes possible to reliably reduce the signal levels at the four sampling points of the first transmission signal before peak reduction (dash-dotted line).

Note that, while the peak signal level of the second transmission signal is lower than the threshold TH in FIGS. 6 and 7 to illustrate the second transmission signal with the peak reduced under the ideal conditions, the signal level before and after the peak in the time axis direction may not be technically zero at the time of generating the peak reduction signal, even though it is approximately zero. In such a case, although a sampling point at which the peak signal level of the second transmission signal becomes equal to or higher than the threshold TH is included, the PAPR of the second transmission signal ultimately transmitted by the transmission device 100 may be sufficiently reduced.

In this regard, the peak processing unit 130 generates a peak reduction signal that reduces signal levels of all samples in such a manner that the signal levels of all the samples whose signal levels are equal to or higher than a predetermined threshold among the peaks of the first transmission signal input from the transmission processing unit 120 are reduced to be lower than the threshold, and outputting the second transmission signal obtained by reducing the peak of the first transmission signal with the peak reduction signal indicates that signal levels at all sampling points of the peak of the second transmission signal are not necessarily lower than the threshold TH and a sampling point at a signal level equal to or higher than the threshold TH is included.

Note that the peak processing unit 130 may use a filter capable of generating a plurality of peak reduction signals to generate the plurality of peak reduction signals through a filtering process instead of generating the plurality of peak reduction signals using the plurality of signal generation units 132.

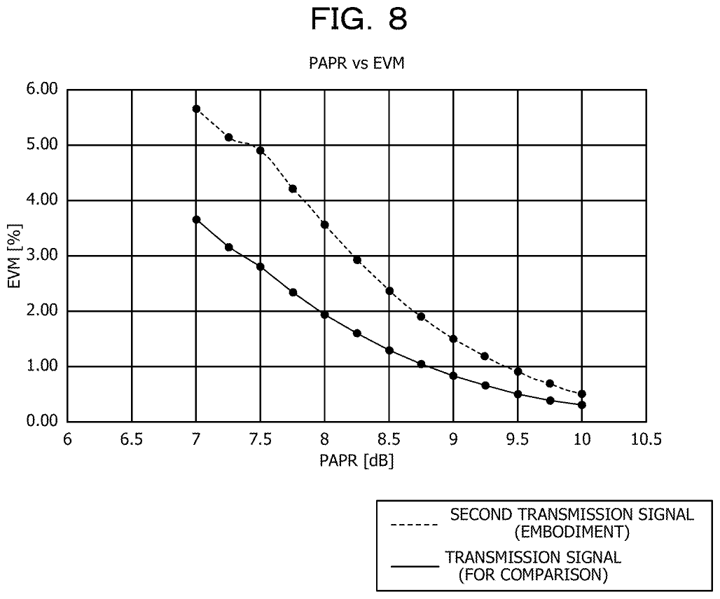

FIG. 8 is a diagram illustrating a relationship between error vector magnitude (EVM) and the PAPR of the second transmission signal transmitted from the antenna 190 of the transmission device 100. In FIG. 8, the solid line represents the relationship between the EVM and the PAPR of the second transmission signal transmitted from the antenna 190 of the transmission device 100, and the broken line represents a relationship between the EVM and the PAPR of the transmission signal transmitted from the antenna 4 (see FIG. 2) of the comparative transmission device.

As illustrated in FIG. 8, the PAPR of the transmission device 100 according to the embodiment is reduced by approximately 5% to approximately 12% at the same EVM as compared to the comparative transmission device. By reducing the PAPR of the second transmission signal, it becomes possible to suppress peak power of the transmission device 100, and to increase options of a PA device.

<Effects>

As described above, the transmission device 100 includes the transmission processing unit 120 that samples the first transmission signal obtained by performing baseband processing on a baseband signal output from the processor 110 and outputs the sampled first transmission signal, the peak processing unit 130 that generates the peak reduction signal for reducing signal levels of all samples in such a manner that the signal levels of all the samples whose signal levels are equal to or higher than a predetermined threshold among the peaks of the first transmission signal input from the transmission processing unit 120 are reduced to be lower than the threshold and outputs the second transmission signal obtained by reducing the peaks of the first transmission signal with the peak reduction signal, and the transmission stage 102 that transmits the second transmission signal output from the peak processing unit 130. Accordingly, it becomes possible to reliably reduce the signal levels of all the samples.

Therefore, it becomes possible to provide the transmission device 100 capable of efficiently reducing the PAPR of the transmission signals.

Furthermore, the transmission device 100 further includes the memory 150 that stores model waveform data of the peak reduction signal, and the peak processing unit 130 generates the peak reduction signal by scaling the model waveform according to the peak signal level equal to or higher than the predetermined threshold of the peak reduction signal. Accordingly, it becomes possible to provide the transmission device 100 capable of accurately and efficiently reducing the PAPR of the transmission signals by using the peak reduction signal generated by scaling the model waveform.

Furthermore, the peak processing unit 130 generates the peak reduction signal by scaling the model waveform for each of the samples having the peak equal to or higher than the predetermined threshold of the peak reduction signal. Accordingly, it becomes possible to provide the transmission device 100 capable of accurately and efficiently reducing the PAPR of the transmission signals for each of the samples having the peak equal to or higher than the predetermined threshold individually.

Furthermore, the model waveform is a model waveform generated by generating the cancellation signal 2 obtained by performing the filtering process for passing components in the frequency band of the first transmission signal on the cancellation signal 1 obtained by inverting a predetermined number of signal levels around the peak of the basic peak reduction signal having a predetermined waveform and adding the basic peak reduction signal and the cancellation signal 2. Accordingly, it becomes possible to generate the model waveform in which the signal level before and after the peak in the time axis direction is set to the approximately zero level highly accurately.

Furthermore, the transmission device 100 includes the transmission processing unit 120 that performs the baseband processing on the baseband signal output from the processor 110 and outputs the first transmission signal, the peak processing unit 130 that generates the peak reduction signal for reducing a signal level of a sample in such a manner that the signal level of the sample of the peak of the first transmission signal input from the transmission processing unit 120 at the signal level equal to or higher than the predetermined threshold is reduced to be lower than the threshold and outputs the second transmission signal obtained by reducing the peak of the first transmission signal with the peak reduction signal, the memory 150 that stores model waveform data of the peak reduction signal, and the transmission stage 102 that transmits the second transmission signal output from the peak processing unit 130, in which the model waveform is a model waveform generated by generating the cancellation signal 2 obtained by performing the filtering process that passes components in the frequency band of the first transmission signal on the cancellation signal 1 obtained by inverting the positive/negative of a predetermined number of signal levels around the peak of the basic peak reduction signal having a predetermined waveform and adding the basic peak reduction signal and the cancellation signal 2, and the peak processing unit 130 generates the peak reduction signal by scaling the model waveform according to the peak signal level equal to or higher than the predetermined threshold of the peak reduction signal. Accordingly, it becomes possible to generate the model waveform in which the signal level before and after the peak in the time axis direction is set to the approximately zero level highly accurately, and to reliably reduce the signal level of the sample using the peak reduction signal generated by scaling the model waveform.

Therefore, it becomes possible to provide the transmission device 100 capable of efficiently reducing the PAPR of the transmission signals. Since the peak reduction signal generated by scaling the model waveform is used, it becomes possible to provide the transmission device 100 capable of accurately and efficiently reducing the PAPR of the transmission signals.

Furthermore, through the filtering process, the cancellation signal 2 is generated by cutting off the components of the cancellation signal 1 in the forbidden bands outside the frequency band of the first transmission signal and adjusting the amplitude of the components of the cancellation signal 1 in the frequency band of the first transmission signal and the components of the cancellation signal 1 outside the forbidden bands outside the frequency band of the first transmission signal. Accordingly, it becomes possible to generate the model waveform in which the signal level before and after the peak in the time axis direction is set to the approximately zero level highly accurately, and to provide the transmission device 100 capable of more accurately and efficiently reducing the PAPR of the transmission signals.

<Model Waveform Generation Method According to Variation of Embodiment>

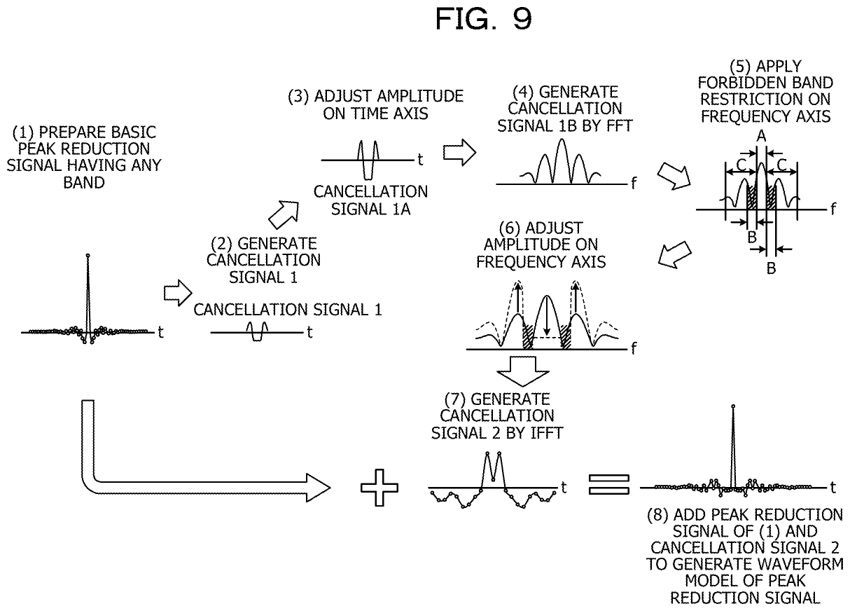

FIG. 9 is a diagram for explaining a method of generating a model waveform of a peak reduction signal to be used by a peak processing unit 130 to generate the peak reduction signal according to a variation of the embodiment. Here, descriptions will be given in a similar manner to FIG. 4. It is sufficient if the model waveform described with reference to FIG. 9 is generated in advance and stored in a memory 150.

Processing of (1) and (2) in FIG. 9 are the same as the processing of (1) and (2) in FIG. 4, and duplicate descriptions are omitted here. A cancellation signal 1 is generated by the processing of (2).

Next, as illustrated in (3), processing of adjusting amplitude is performed on the cancellation signal 1 on a time axis. For example, amplitude adjustment processing for increasing or decreasing the amplitude is performed on the cancellation signal 1 according to a signal level position in the time axis direction, thereby generating a cancellation signal 1A.

Next, as illustrated in (4), Fast Fourier Transformation (FFT) is performed on the cancellation signal 1A, thereby generating a cancellation signal 1B.

Next, as illustrated in (5), components of the cancellation signal 1B in the forbidden bands B are cut off using the band A, the forbidden bands B, and the bands C illustrated in FIG. 4.

Next, as illustrated in (6), the amplitude adjustment processing is carried out in such a manner that amplitude of components in the band A of the cancellation signal 1B (solid line) whose components in the forbidden bands B are cut off in (5) is adjusted to be small and the amplitude of the components in the bands C other than the forbidden bands B is increased.

Next, Inverse Fast Fourier Transformation (IFFT) is performed on the cancellation signal 1B (broken line) having been subject to the amplitude adjustment processing in (6), thereby generating a cancellation signal 2 illustrated in (7).

Finally, as illustrated in (8), the basic peak reduction signal prepared in (1) is combined with the cancellation signal 2 generated in (7), whereby the model waveform of the peak reduction signal is complete. The level before and after the peak of the model waveform of the peak reduction signal is the approximately zero level in the time axis direction.

As described above, according to the variation, the cancellation signal 2 is generated by, in the filtering process, performing the Fourier transform on the cancellation signal 1, cutting off the components of the cancellation signal 1 having been subject to the Fourier transform in the forbidden bands outside the frequency band of the first transmission signal, adjusting the amplitude of the components of the cancellation signal 1 having been subject to the Fourier transform in the frequency band of the first transmission signal and the components of the cancellation signal 1 having been subject to the Fourier transform outside the forbidden bands outside the frequency band of the first transmission signal, and further performing the inverse Fourier transform. Accordingly, it becomes possible to generate the model waveform in which the signal level before and after the peak in the time axis direction is set to the approximately zero level highly accurately, and to provide the transmission device 100 capable of more accurately and efficiently reducing the PAPR of the transmission signals. Note that the model waveform generation method according to the variation of the embodiment illustrated in FIG. 9 and the model waveform generation method according to the embodiment illustrated in FIG. 4 may be combined.

Although the transmission device according to the exemplary embodiment of the present disclosure has been described above, the present disclosure is not limited to the embodiment disclosed in detail, and various changes and alterations may be made hereto without departing from the scope of claims.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A transmission device comprising:
a memory; and
a processor coupled to the memory and configured to:
sample a first transmission signal obtained by performing baseband processing on a baseband signal;
output the sampled first transmission signal;
generate a peak reduction signal that reduces a signal level of all samples in such a manner that the signal level of all the samples of a peak of the first transmission signal with the signal level equal to or higher than a predetermined threshold is reduced to be lower than the threshold;
output a second transmission signal obtained by reducing the peak of the first transmission signal with the peak reduction signal; and
transmit the second transmission signal.

2. The transmission device according to claim 1, wherein the processor:
stores data of a model waveform of the peak reduction signal; and
generates the peak reduction signal by scaling the model waveform according to the signal level of the peak of the peak reduction signal equal to or higher than the predetermined threshold.

3. The transmission device according to claim 2, wherein the processor generates the peak reduction signal by scaling the model waveform for each of the samples with the peak equal to or higher than the predetermined threshold of the peak reduction signal.

4. The transmission device according to claim 2, wherein the model waveform includes a model waveform generated by generating a second inverted signal obtained by performing a filtering process that passes a component in a frequency band of the first transmission signal on a first inverted signal obtained by inverting a predetermined number of signal levels around a peak of a basic peak reduction signal with a predetermined waveform and adding the basic peak reduction signal and the second inverted signal.

5. A transmission device comprising:
a memory; and
a processor coupled to the memory and configured to:
perform baseband processing on a baseband signal;
output a first transmission signal;
generate a peak reduction signal that reduces a signal level of a sample in such a manner that the signal level of the sample of a peak of the first transmission signal with the signal level equal to or higher than a predetermined threshold is reduced to be lower than the threshold and outputs a second transmission signal obtained by reducing the peak of the first transmission signal with the peak reduction signal;
store data of a model waveform of the peak reduction signal; and
transmit the second transmission signal, wherein
the model waveform includes a model waveform generated by generating a second inverted signal obtained by performing a filtering process that passes a component in a frequency band of the first transmission signal on a first inverted signal obtained by inverting a predetermined number of signal levels around a peak of a basic peak reduction signal with a predetermined waveform and adding the basic peak reduction signal and the second inverted signal, and
the processor generates the peak reduction signal by scaling the model waveform according to the signal level of the peak equal to or higher than the predetermined threshold of the peak reduction signal.

6. The transmission device according to claim 5, wherein the second inverted signal includes a signal generated by, in the filtering process, cutting off the component of the first inverted signal in a forbidden band outside the frequency band of the first transmission signal and adjusting amplitude of the component of the first inverted signal in the frequency band of the first transmission signal and the component of the first inverted signal outside the forbidden band outside the frequency band of the first transmission signal.

7. The transmission device according to claim 5, wherein the second inverted signal includes a signal generated by, in the filtering process, performing a Fourier transform on the first inverted signal, cutting off the component of the first inverted signal that has been subject to the Fourier transform in a forbidden band outside the frequency band of the first transmission signal, adjusting amplitude of the component of the first inverted signal that has been subject to the Fourier transform in the frequency band of the first transmission signal and the component of the first inverted signal that has been subject to the Fourier transform outside the forbidden band outside the frequency band of the first transmission signal, and further performing an inverse Fourier transform.
